(19) United States
(12) Patent Application Publication
(10) Pub. No.: US 2021/0263317 A1
(43) Pub. Date: Aug. 26, 2021

(54) ANGULARLY SELECTIVE DIFFUSIVE COMBINER

(71) Applicant: Facebook Technologies, LLC, Menlo Park, CA (US)

(72) Inventors: Oleg Yaroshchuk, Redmond, WA (US); Alireza Moheghi, Bothell, WA (US); Yusufu Njoni Bamaxam Sulai, Snohomish, WA (US)

(21) Appl. No.: 16/800,865

(22) Filed: Feb. 25, 2020

(51) Int. Cl. G02B 27/01; G06T 19/00

(52) U.S. Cl. CPC G02B 27/0172; G06T 19/006; G02B 2027/0138; G02B 2027/014; G02B 2027/0178

(57) ABSTRACT

An augmented reality/mixed reality/virtual reality (AR/MR/VR) display configured to output artificial reality content comprising an angularly selective diffusive combiner and a projector configured to project a virtual image on the angularly selective diffusive combiner is disclosed. The angularly selective diffusive combiner comprises first and second opposing surfaces with a first material disposed in between. The angularly selective diffusive combiner also comprises a second material disposed between the first and second opposing surfaces, the second material having an optical index of refraction substantially matching the optical index of refraction of the first material for light normally incident to the first and second surfaces at a first angle and an optical index of refraction different from the optical index of refraction of the first material for light incident to the first and second surfaces at an angle.

### TECHNICAL FIELD

This disclosure generally relates to optical elements and optical systems implemented in various types of electronic systems and devices.

### BACKGROUND

Optical devices, including head-mounted display (HMD) devices, provide visual information to a user. For example, head-mounted displays are used for virtual reality (VR), augmented reality (AR) and mixed reality (MR) operations. A head-mounted display often includes an electronic image source and an optical assembly.

In some augmented reality applications, a virtual image including virtual objects is combined with real-world objects in the field of view of an optical system, such as a user's eye. A combiner is an optical element that redirects light from an electronic image source toward the optical system, for example, beam splitters, semi-transparent windows, diffusers, and the like.

### SUMMARY

In general, the present disclosure is directed to an angularly selective diffusive combiner that can be used as a light combiner for an AR/MR/VR device. The diffusive combiner can be formed from a mixture of isotropic polymer and liquid crystal, for example, a polymer dispersed liquid crystal (PDLC) material. The isotropic polymer and liquid crystal (LC), as well as alignment of LC domains, may be selected so that the refractive indices of these components match, or substantially match, for light that is incident to the diffusive combiner at a first angle or range of angles (e.g., substantially normal to a major surface of the diffusive combiner) and do not match for light that is incident on the diffuser at a second, different angle or range of angles (e.g., light that is incident to the major surface of the diffusive combiner at a non-perpendicular angle). This makes the diffusive combiner substantially transparent to incident light that is incident at the first angle or range of angles to the surface of the diffusive combiner but diffuse to light that is incident at the second angle or range of angles to the surface of the diffusive combiner. As such, by positioning a projector at a position at the second angle or within the second range of angles, the diffusive combiner can transparently transmit light from the real world and scatter light from a projector located off-axis from the diffusive combiner.

The diffusive combiner can be relatively insensitive to the polarization of light that is incident at the first angle or range of angles. In some examples, the diffusive combiner can be more efficient at scattering p-polarized light that is incident at the second angle or range of angles. In addition, the diffusive combiner can be passive or active, e.g. electrically controlled. The passive angularly selective diffusive combiner can contribute to reducing power consumption by an AR/VR headset incorporating the passive angularly selective diffusive combiner as a light combiner. An active angularly selective diffusive combiner can also function as a shutter. For example, a liquid crystal material having a negative dielectric anisotropy, e.g., a negative delta epsilon, can be selected for use in the angularly selective diffusive combiner so that an electric field can be applied across the layer of the diffusive combiner to orient the liquid crystal directors parallel to the plane of the diffusive combiner, thereby acting as a shutter by at least partially reducing the transmission of the diffusive combiner. Conversely, in some examples, a liquid crystal material having a positive dielectric anisotropy, e.g., a positive delta epsilon, can be selected for use in the angularly selective diffusive combiner so that an electric field can be applied across the layer of the diffusive combiner to orient the liquid crystal directors parallel to the plane of the diffusive combiner, thereby acting as a shutter by at least partially reducing the transmission of the diffusive combiner. In some examples, an active angularly selective diffusive combiner may substantially reduce the transmission of the diffusive combiner, thereby allowing an AR/MR/VR headset to function as a VR device by blocking the light from a real-world scene.

In some examples, an angularly selective diffusive combiner may be formed by photopolymerizing a mixture of a polymer precursor and liquid crystal material in the presence of a magnetic or electric field. The magnetic or electric field orients the liquid crystal phase separated during photopolymerization (i.e., LC droplets or domains within a polymer matrix), thereby setting the preferential alignment direction of the liquid crystal within these domains, which remains after removing the applied field due to anchoring at the LC-Polymer interface. The preferential direction of the liquid crystal can be controlled by setting the direction of the magnetic or electric field during polymerization, for example, the preferential direction of the liquid crystal can be perpendicular relative to the substrate surfaces of the diffusive combiner or at a tilt angle.

The diffusive combiner can be substantially nondispersive, such that different colors of light scatter at approximately the same angle or range of angles. A substantially nondispersive diffusive combiner can significantly reduce or eliminate rainbow artifacts.

In some examples, the disclosure describes a device configured to output artificial reality content. The device comprises an angularly selective diffusive combiner configured to transparently transmit light normally incident to the angularly selective diffusive combiner and to diffusively scatter light incident to the angularly selective diffusive combiner at a non-perpendicular angle. The device also comprises a projector configured to project a virtual image on the angularly selective diffusive combiner at the non-perpendicular angle, wherein the angularly selective diffusive combiner is configured to direct at least some light from the virtual image toward an eyebox.

In some examples, the disclosure describes a method of forming an angularly selective diffuser comprising providing liquid crystal dispersed in a precursor of an isotropic polymer between a first surface and a second surface. The method also comprises applying an anchoring condition aligning a liquid crystal dispersed in the precursor of the isotropic polymer along a predetermined axis, and polymerizing the polymer in the presence of the anchoring condition to form a polymer dispersed liquid crystal (PDLC) with liquid crystal droplets and/or domains substantially aligned based on the orientation of the at least one of the magnetic field or the electric field.

In some examples, the disclosure describes an angularly selective diffusive combiner comprising first and second opposing surfaces and a first material disposed between the first and second opposing surfaces. The angularly selective diffusive combiner also comprises a second material disposed between the first and second opposing surfaces, the second material having an optical index of refraction substantially matching the optical index of refraction of the first material for light normally incident to the first and second surfaces at a first angle and an optical index of refraction different from the optical index of refraction of the first material for light incident to the first and second surfaces at an angle.

Thus, the disclosed embodiments provide an angularly selective diffusive combiner that is transparent to near-normal incidence light and can scatter off-axis light, and that can function as a combiner for AR/VR operations, such as for an AR/VR head-mounted display.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures. The figures are not drawn to scale unless indicated otherwise.

FIG. 1 is an illustration depicting an example artificial reality system that includes an angularly selective diffusive combiner, in accordance with the techniques described in this disclosure.

FIG. 2A is an illustration depicting an example HMD that includes an angularly selective diffusive combiner, in accordance with techniques described in this disclosure.

FIG. 2B is an illustration depicting another example HMD that includes an angularly selective diffusive combiner, in accordance with techniques described in this disclosure.

FIG. 3 is a block diagram showing example implementations of a console and an HMD of the artificial reality system of FIG. 1, in accordance with techniques described in this disclosure.

FIG. 4 is a block diagram depicting an example HMD of the artificial reality system of FIG. 1, in accordance with the techniques described in this disclosure.

FIG. 5 is an illustration depicting an example artificial reality system that includes an angularly selective diffusive combiner, in accordance with the techniques described in this disclosure.

FIG. 6 is an illustration depicting another example artificial reality system that includes an angularly selective diffusive combiner, in accordance with the techniques described in this disclosure.

FIG. 7 is an illustration depicting an example angularly selective diffusive combiner, in accordance with techniques described in this disclosure.

FIG. 8 is another illustration depicting an example angularly selective diffusive combiner, in accordance with techniques described in this disclosure.

FIG. 9 is an illustration depicting one or more angularly selective diffusive combiners in a stereoscopic artificial reality system, in accordance with techniques described in this disclosure.

FIG. 10 is an illustration depicting another one or more angularly selective diffusive combiners in a stereoscopic artificial reality system, in accordance with techniques described in this disclosure.

FIG. 11 is an illustration depicting another example angularly selective diffusive combiner in an artificial reality system, in accordance with techniques described in this disclosure.

FIG. 12 is a flowchart illustrating an example method of making an angularly selective diffusive combiner, in accordance with techniques described in this disclosure.

FIG. 13 is a flowchart illustrating another example method of making an angularly selective diffusive combiner, in accordance with techniques described in this disclosure.

FIG. 14 is an illustration depicting example method steps for making an angularly selective diffusive combiner having liquid crystal with a vertical preferential alignment angle, in accordance with techniques described in this disclosure.

FIG. 15 is an illustration depicting example method steps for making an angularly selective diffusive combiner having liquid crystal with a tilted preferential alignment angle, in accordance with techniques described in this disclosure.

FIG. 16 is an illustration depicting an example angularly selective diffusive combiner, in accordance with techniques described in this disclosure.

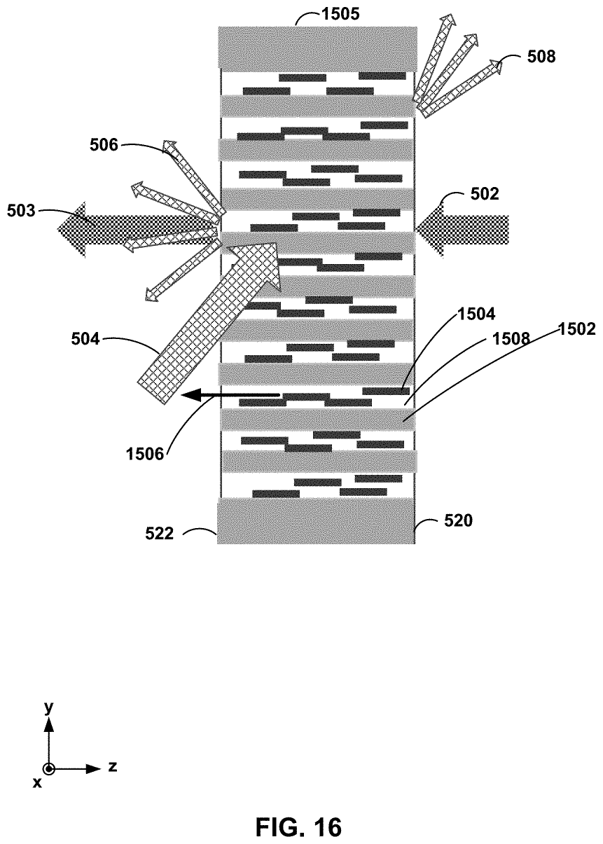

### DETAILED DESCRIPTION

The present disclosure is directed to an angularly selective diffusive combiner and a display device (e.g. a head-mounted display device) including the angularly selective diffusive combiner. In some examples, the diffusive combiner can be substantially transparent (e.g., transparent or nearly transparent) for light that is incident to a major surface of the diffusive combiner at a first angle or range of angles, and scattering for light that is incident to a major surface of the diffusive combiner at a second angle or range of angles. In some examples, the diffusive combiner can be substantially transparent for light that is normally incident, or substantially normally incident, to a major surface of the diffusive combiner, e.g. light that is incident perpendicular to the major surface of the diffusive combiner. The diffusive combiner can be scattering for light that is incident to a major surface of the diffusive combiner at off-axis, or substantially off-axis, angles, e.g. light that is incident to the major surface of the diffusive combiner at a non-perpendicular angle or range of non-perpendicular angles. The angularly selective diffusive combiner can include a mixture and/or a composite including isotropic polymer and liquid crystal, for example, a polymer dispersed liquid crystal (PDLC) material. The disclosed examples can be used to provide virtual content to a real scene to provide a mixed reality (MR) or augmented reality (AR) experience to a user of an AR/VR system.

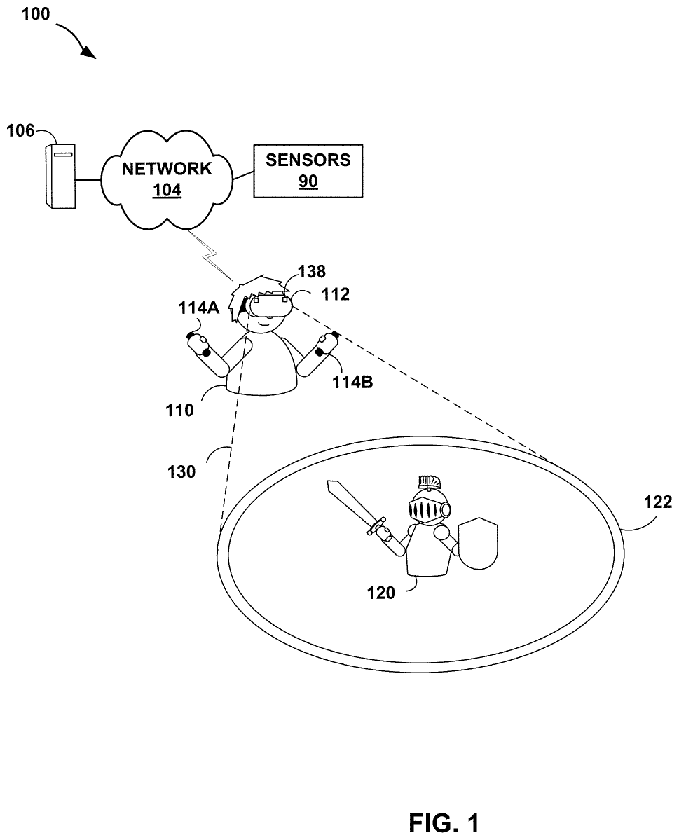

FIG. 1 is an illustration depicting an example artificial reality system includes an angularly selective diffusive combiner, in accordance with the techniques described in this disclosure. In the example of FIG. 1, artificial reality system 100 includes HMD 112, one or more controllers 114A and 114B (collectively, “controller(s) 114”), and may in some examples include one or more external sensors 90 and/or a console 106.

HMD 112 is typically worn by user 110 and includes an electronic display and optical assembly for presenting artificial reality content 122 to user 110. In addition, HMD 112 includes one or more sensors (e.g., accelerometers) for tracking motion of the HMD 112 and may include one or more image capture devices 138 (e.g., cameras, line scanners) for capturing image data of the surrounding physical environment. Although illustrated as a head-mounted display, AR system 100 may alternatively, or additionally, include glasses or other display devices for presenting artificial reality content 122 to user 110.

Each controller(s) 114 is an input device that user 110 may use to provide input to console 106, HMD 112, or another component of artificial reality system 100. Controller 114 may include one or more presence-sensitive surfaces for detecting user inputs by detecting a presence of one or more objects (e.g., fingers, stylus) touching or hovering over locations of the presence-sensitive surface. In some examples, controller(s) 114 may include an output display, which may be a presence-sensitive display. In some examples, controller(s) 114 may be a smartphone, tablet computer, personal data assistant (PDA), or other hand-held device. In some examples, controller(s) 114 may be a smartwatch, smartring, or other wearable device. Controller(s) 114 may also be part of a kiosk or other stationary or mobile system. Alternatively, or additionally, controller(s) 114 may include other user input mechanisms, such as one or more buttons, triggers, joysticks, D-pads, or the like, to enable a user to interact with and/or control aspects of the artificial reality content 122 presented to user 110 by artificial reality system 100.

In this example, console 106 is shown as a single computing device, such as a gaming console, workstation, a desktop computer, or a laptop. In other examples, console 106 may be distributed across a plurality of computing devices, such as distributed computing network, a data center, or cloud computing system. Console 106, HMD 112, and sensors 90 may, as shown in this example, be communicatively coupled via network 104, which may be a wired or wireless network, such as Wi-Fi, a mesh network or a short-range wireless communication medium, or combination thereof. Although HMD 112 is shown in this example as being in communication with, e.g., tethered to or in wireless communication with, console 106, in some implementations HMD 112 operates as a stand-alone, mobile artificial reality system, and artificial reality system 100 may omit console 106.

In general, artificial reality system 100 renders artificial reality content 122 for display to user 110 at HMD 112. In the example of FIG. 1, a user 110 views the artificial reality content 122 constructed and rendered by an artificial reality application executing on HMD 112 and/or console 106. In some examples, the artificial reality content 122 may be fully artificial, i.e., images not related to the environment in which user 110 is located. In some examples, artificial reality content 122 may comprise a mixture of real-world imagery (e.g., a hand of user 110, controller(s) 114, other environmental objects near user 110) and virtual objects 120 to produce mixed reality and/or augmented reality. In some examples, virtual content items may be mapped (e.g., pinned, locked, placed) to a particular position within artificial reality content 122, e.g., relative to real-world imagery. A position for a virtual content item may be fixed, as relative to one of a wall or the earth, for instance. A position for a virtual content item may be variable, as relative to controller(s) 114 or a user, for instance. In some examples, the particular position of a virtual content item within artificial reality content 122 is associated with a position within the real-world, physical environment (e.g., on a surface of a physical object).

During operation, the artificial reality application constructs artificial reality content 122 for display to user 110 by tracking and computing pose information for a frame of reference, typically a viewing perspective of HMD 112. Using HMD 112 as a frame of reference, and based on a current field of view as determined by a current estimated pose of HMD 112, the artificial reality application renders 3D artificial reality content which, in some examples, may be overlaid, at least in part, upon the real-world, 3D physical environment of user 110. During this process, the artificial reality application uses sensed data received from HMD 112, such as movement information and user commands, and, in some examples, data from any external sensors 90, such as external cameras, to capture 3D information within the real world, physical environment, such as motion by user 110 and/or feature tracking information with respect to user 110. Based on the sensed data, the artificial reality application determines a current pose for the frame of reference of HMD 112 and, in accordance with the current pose, renders the artificial reality content 122.

Artificial reality system 100 may trigger generation and rendering of virtual content items based on a current field of view 130 of user 110, as may be determined by real-time gaze tracking of the user, or other conditions. More specifically, image capture devices 138 of HMD 112 capture image data representative of objects in the real-world, physical environment that are within a field of view 130 of image capture devices 138. Field of view 130 typically corresponds with the viewing perspective of HMD 112. In some examples, the artificial reality application presents artificial reality content 122 comprising mixed reality and/or augmented reality. The artificial reality application may render images of real-world objects, such as the portions of a peripheral device, the hand, and/or the arm of the user 110, that are within field of view 130 along with virtual objects 120, such as within artificial reality content 122. In other examples, the artificial reality application may render virtual representations of the portions of a peripheral device, the hand, and/or the arm of the user 110 that are within field of view 130 (e.g., render real-world objects as virtual objects 120) within artificial reality content 122. In either example, user 110 is able to view the portions of their hand, arm, a peripheral device and/or any other real-world objects that are within field of view 130 within artificial reality content 122. In other examples, the artificial reality application may not render representations of the hand or arm of user 110.

To provide virtual content overlaid with real-world objects in a scene, the HMD 112 can include a light combiner. In accordance with examples disclosed herein, the light combiner can include an angularly selective diffusive combiner positioned at least partially within the field of view 130. In some examples, the angularly selective diffusive combiner fills the entire field of view 130. The user 110 is able to view the scene of the real world within the field of view 130 through the angularly selective diffusive combiner, which is substantially transparent to light passing through the angularly selective diffusive combiner at normal incidence, or near-normal incidence (e.g. to within 30 degrees from normal), that is, perpendicular or near-perpendicular to a major surface of the diffusive combiner. The HMD 112 can include a projector positioned to illuminate the angularly selective diffusive combiner with virtual content at an off-axis angle to a major surface of the diffusive combiner. The angularly selective diffusive combiner can then scatter the off-axis light from the projector such that at least a portion of the light is directed towards the eyes of user 110, thereby overlaying the virtual image projected on the angularly selective diffusive combiner with the real-world scene within field of view 130 of user 110.

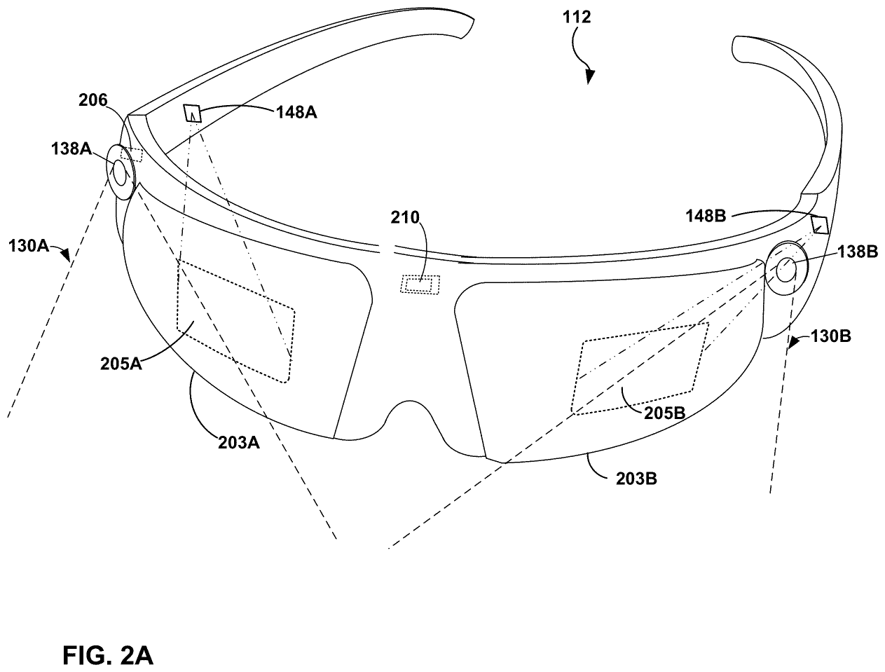

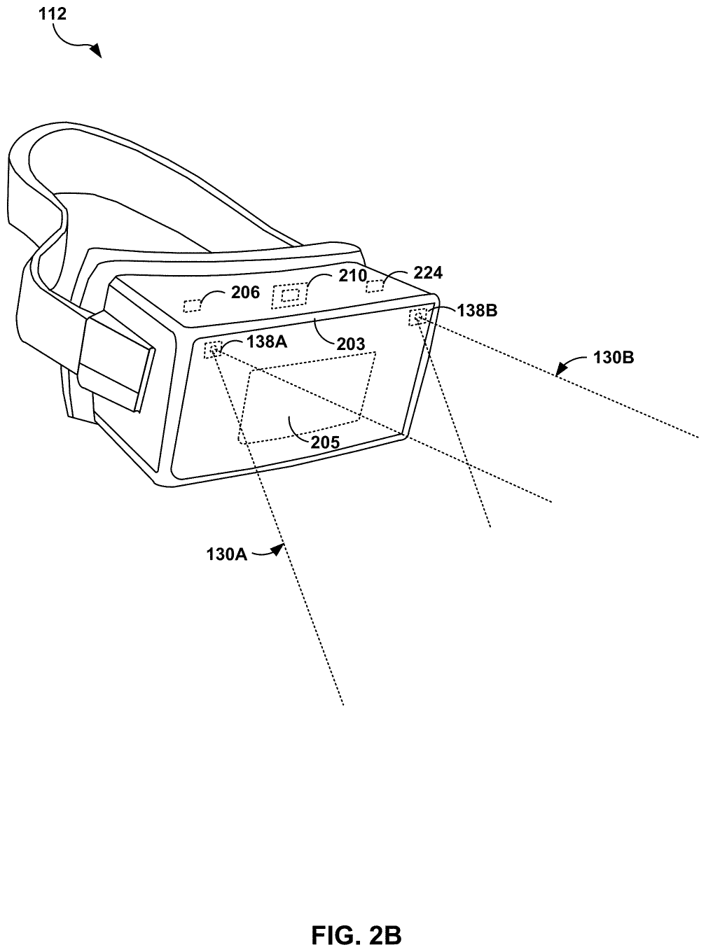

FIG. 2A is an illustration depicting an example HMD 112 that includes an angularly selective diffusive combiner, in accordance with techniques described in this disclosure. HMD 112 of FIG. 2A may be an example of HMD 112 of FIG. 1. As shown in FIG. 2A, HMD 112 may take the form of glasses. HMD 112 may be part of an artificial reality system, such as artificial reality system 100 of FIG. 1, or may operate as a stand-alone, mobile artificial realty system configured to implement the techniques described herein.

In this example, HMD 112 are glasses comprising a front frame including a bridge to allow the HMD 112 to rest on a user's nose and temples (or “arms”) that extend over the user's ears to secure HMD 112 to the user. In addition, HMD 112 of FIG. 2A includes one or more windows 203A and 203B (collectively, “windows 203”) and one or more angularly selective diffusive combiners 205A and 205B (collectively, “angularly selective diffusive combiners 205”) configured to scatter light output by one or more projectors 148A and 148B (collectively, “projectors 148”) thereby acting as a projector screen for the off-axis illumination of the projectors 148. In some examples, the known orientation and position of windows 203 relative to the front frame of HMD 112 is used as a frame of reference, also referred to as a local origin, when tracking the position and orientation of HMD 112 for rendering artificial reality content according to a current viewing perspective of HMD 112 and the user. In some examples, the projectors 148 can provide a stereoscopic display for providing separate images to each eye of the user.

In the example shown, the angularly selective diffusive combiners 205 cover a portion of the windows 203, subtending a portion of the field of view 130 viewable by a user 110 through the windows 203. In other examples, the angularly selective diffusive combiners 205 can cover other portions of the windows 203, or the entire area of the windows 205.

As further shown in FIG. 2A, in this example, HMD 112 further includes one or more motion sensors 206, one or more integrated image capture devices 138A and 138B (collectively, “image capture devices 138”), an internal control unit 210, which may include an internal power source and one or more printed-circuit boards having one or more processors, memory, and hardware to provide an operating environment for executing programmable operations to process sensed data and present artificial reality content on the angularly selective diffusive combiners 205.

FIG. 2B is an illustration depicting another example HMD 112, in accordance with techniques described in this disclosure. HMD 112 may be part of an artificial reality system, such as artificial reality system 100 of FIG. 1, or may operate as a stand-alone, mobile artificial realty system configured to implement the techniques described herein.

In this example, HMD 112 includes a front rigid body and a band to secure HMD 112 to a user. In addition, HMD 112 includes a window 203 configured to present artificial reality content to the user via an angularly selective diffusive combiner 205. In some examples, the known orientation and position of window 203 relative to the front rigid body of HMD 112 is used as a frame of reference, also referred to as a local origin, when tracking the position and orientation of HMD 112 for rendering artificial reality content according to a current viewing perspective of HMD 112 and the user. In other examples, HMD 112 may take the form of other wearable head mounted displays, such as glasses or goggles.

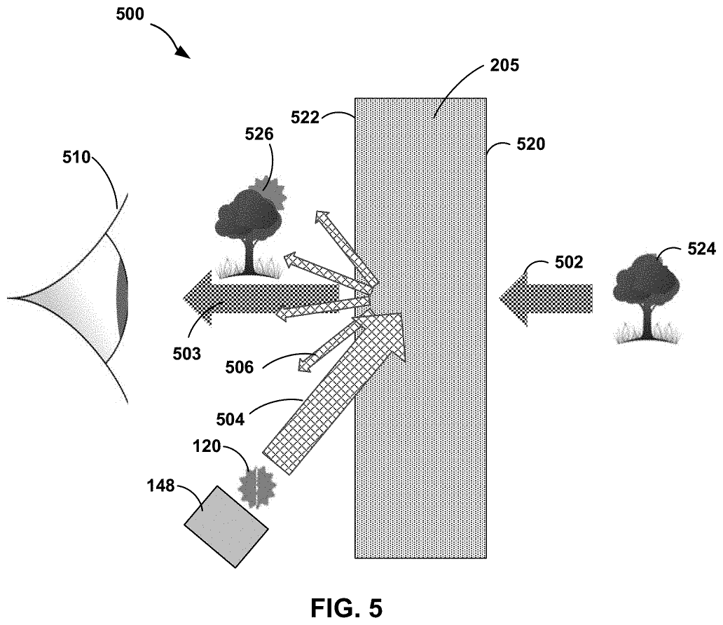

The angularly selective diffusive combiners 205 can include optical elements configured to manage light output by the projectors 148 for viewing by the user of HMD 112 (e.g., user 110 of FIG. 1). The optical elements may include, for example, a PDLC. For example, angularly selective diffusive combiners 205 can be any of the angularly selective diffusive combiners described herein with reference to FIGS. 5-15.

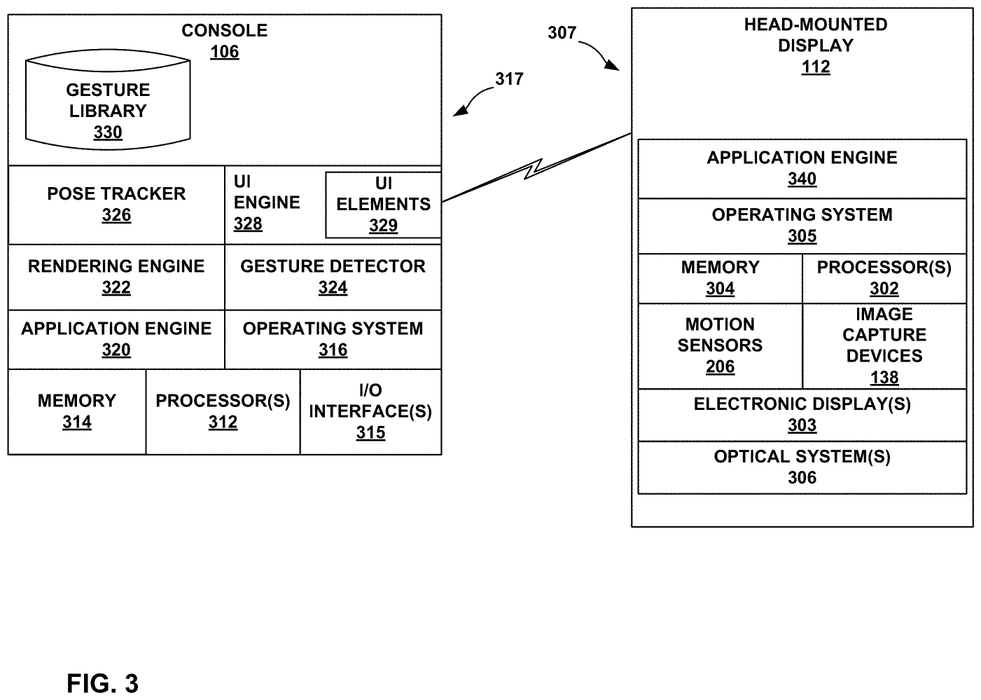

FIG. 3 is a block diagram showing example implementations of an artificial reality system that includes console 106 and HMD 112, in accordance with techniques described in this disclosure. In the example of FIG. 3, console 106 performs pose tracking, gesture detection, and user interface generation and rendering for HMD 112 based on sensed data, such as motion data and image data received from HMD 112 and/or external sensors.

In this example, HMD 112 includes one or more processors 302 and memory 304 that, in some examples, provide a computer platform for executing an operating system 305, which may be an embedded, real-time multitasking operating system, for instance, or other type of operating system. In turn, operating system 305 provides a multitasking operating environment for executing one or more software components 307, including application engine 340. As discussed with respect to the examples of FIGS. 2A and 2B, processors 302 are coupled to electronic display 303, motion sensors 206, image capture devices 138, and, in some examples, optical system 306. In some examples, processors 302 and memory 304 may be separate, discrete components. In other examples, memory 304 may be on-chip memory collocated with processors 302 within a single integrated circuit.

In some examples, the optical system 306 may include one or more angularly selective diffusive combiners 205. The angularly selective diffusive combiners 205 can include optical elements configured to manage light output by the projectors 148 for viewing by the user of HMD 112 (e.g., user 110 of FIG. 1). The optical elements may include, for example, a PDLC. For example, angularly selective diffusive combiners 205 can be any of the angularly selective diffusive combiners described herein with reference to FIGS. 5-15.

In general, console 106 is a computing device that processes image and tracking information received from image capture devices 138 to perform gesture detection and user interface and/or virtual content generation for HMD 112. In some examples, console 106 is a single computing device, such as a workstation, a desktop computer, a laptop, or gaming system. In some examples, at least a portion of console 106, such as processors 312 and/or memory 314, may be distributed across a cloud computing system, a data center, or across a network, such as the Internet, another public or private communications network, for instance, broadband, cellular, Wi-Fi, and/or other types of communication networks for transmitting data between computing systems, servers, and computing devices.

In the example of FIG. 3, console 106 includes one or more processors 312 and memory 314 that, in some examples, provide a computer platform for executing an operating system 316, which may be an embedded, real-time multitasking operating system, for instance, or other type of operating system. In turn, operating system 316 provides a multitasking operating environment for executing one or more software components 317. Processors 312 are coupled to one or more I/O interfaces 315, which provides one or more I/O interfaces for communicating with external devices, such as a keyboard, game controller(s), display device(s), image capture device(s), HMD(s), peripheral device(s), and the like. Moreover, the one or more I/O interfaces 315 may include one or more wired or wireless network interface controllers (NICs) for communicating with a network, such as network 104.

Software applications 317 of console 106 operate to provide an overall artificial reality application. In this example, software applications 317 include application engine 320, rendering engine 322, gesture detector 324, pose tracker 326, and user interface engine 328.

In general, application engine 320 includes functionality to provide and present an artificial reality application, e.g., a teleconference application, a gaming application, a navigation application, an educational application, training or simulation applications, and the like. Application engine 320 may include, for example, one or more software packages, software libraries, hardware drivers, and/or Application Program Interfaces (APIs) for implementing an artificial reality application on console 106. Responsive to control by application engine 320, rendering engine 322 generates 3D artificial reality content for display to the user by application engine 340 of HMD 112.

Application engine 320 and rendering engine 322 construct the artificial content for display to user 110 in accordance with current pose information for a frame of reference, typically a viewing perspective of HMD 112, as determined by pose tracker 326. Based on the current viewing perspective, rendering engine 322 constructs the 3D, artificial reality content which may in some cases be overlaid, at least in part, upon the real-world 3D environment of user 110. During this process, pose tracker 326 operates on sensed data received from HMD 112, such as movement information and user commands, and, in some examples, data from any external sensors 90 (FIG. 1), such as external cameras, to capture 3D information within the real-world environment, such as motion by user 110 and/or feature tracking information with respect to user 110. Based on the sensed data, pose tracker 326 determines a current pose for the frame of reference of HMD 112 and, in accordance with the current pose, constructs the artificial reality content for communication, via the one or more I/O interfaces 315, to HMD 112 for display to user 110.

Pose tracker 326 may determine a current pose for HMD 112 and, in accordance with the current pose, triggers certain functionality associated with any rendered virtual content (e.g., places a virtual content item onto a virtual surface, manipulates a virtual content item, generates and renders one or more virtual markings, generates and renders a laser pointer). In some examples, pose tracker 326 detects whether the HMD 112 is proximate to a physical position corresponding to a virtual surface (e.g., a virtual pinboard), to trigger rendering of virtual content.

User interface engine 328 is configured to generate virtual user interfaces for rendering in an artificial reality environment. User interface engine 328 generates a virtual user interface to include one or more virtual user interface elements 329, such as a virtual drawing interface, a selectable menu (e.g., drop-down menu), virtual buttons, a directional pad, a keyboard, or other user-selectable user interface elements, glyphs, display elements, content, user interface controls, and so forth.

Console 106 may output this virtual user interface and other artificial reality content, via a communication channel, to HMD 112 for display at HMD 112.

Based on the sensed data from any of the image capture devices 138, or other sensor devices, gesture detector 324 analyzes the tracked motions, configurations, positions, and/or orientations of controllers 114 and/or objects (e.g., hands, arms, wrists, fingers, palms, thumbs) of the user 110 to identify one or more gestures performed by user 110. More specifically, gesture detector 324 analyzes objects recognized within image data captured by image capture devices 138 of HMD 112 and/or sensors 90 and external cameras 102 to identify controller(s) 114 and/or a hand and/or arm of user 110, and track movements of controller(s) 114, hand, and/or arm relative to HMD 112 to identify gestures performed by user 110. In some examples, gesture detector 324 may track movement, including changes to position and orientation, of controller(s) 114, hand, digits, and/or arm based on the captured image data, and compare motion vectors of the objects to one or more entries in gesture library 330 to detect a gesture or combination of gestures performed by user 110. In some examples, gesture detector 324 may receive user inputs detected by presence-sensitive surface(s) of controller(s) 114 and process the user inputs to detect one or more gestures performed by user 110 with respect to controller(s) 114.

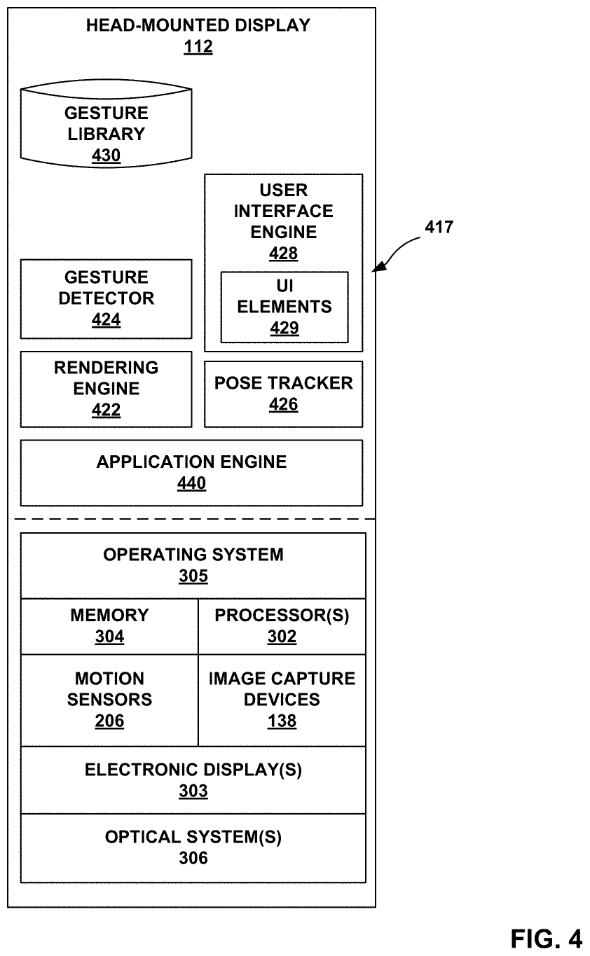

FIG. 4 is a block diagram depicting an example in which HMD 112 is a standalone artificial reality system, in accordance with the techniques described in this disclosure. In this example, like FIG. 3, HMD 112 includes one or more processors 302 and memory 304 that, in some examples, provide a computer platform for executing an operating system 305, which may be an embedded, real-time multitasking operating system, for instance, or other type of operating system. In turn, operating system 305 provides a multitasking operating environment for executing one or more software components 417. Moreover, processor(s) 302 are coupled to electronic display(s) 303, optical system(s) 306, motion sensors 206, and image capture devices 138.

In some examples, the optical system 306 may include one or more angularly selective diffusive combiners 205. The angularly selective diffusive combiners 205 can include optical elements configured to manage light output by the projectors 148 for viewing by the user of HMD 112 (e.g., user 110 of FIG. 1). The optical elements may include, for example, a PDLC. For example, angularly selective diffusive combiners 205 can be any of the angularly selective diffusive combiners described herein with reference to FIGS. 5-15.

In the example of FIG. 4, software components 417 operate to provide an overall artificial reality application. In this example, software applications 417 include application engine 440, rendering engine 422, gesture detector 424, pose tracker 426, and user interface engine 428. In various examples, software components 417 operate similar to the counterpart components of console 106 of FIG. 3 (e.g., application engine 320, rendering engine 322, gesture detector 324, pose tracker 326, and user interface engine 328) to construct virtual user interfaces overlaid on, or as part of, the artificial content for display to user 110.

Similar to the examples described with respect to FIG. 3, based on the sensed data from any of the image capture devices 138 or 102, controller(s) 114, or other sensor devices, gesture detector 424 analyzes the tracked motions, configurations, positions, and/or orientations of controller(s) 114 and/or objects (e.g., hands, arms, wrists, fingers, palms, thumbs) of the user to identify one or more gestures performed by user 110.

FIG. 5 is an illustration depicting an example artificial reality system 500 that includes an angularly selective diffusive combiner, in accordance with the techniques described in this disclosure. In some examples, the artificial reality system 500 includes a projector 148 and an angularly selective diffusive combiner 205. The example shown also includes a user's eye 510, for example, one or more eyes 510 of user 110 as illustrated in FIG. 1.

In the example shown, the angularly selective diffusive combiner 205 is substantially transparent for light 502 incident to a major surface 520 of the angularly selective diffusive combiner 205 at a first angle or range of angles. In the example shown, the light 502 is incident to the surface 520 at normal incidence or at near-normal incidence, e.g. incident on surface 520 at an angle between about −45° and about 45°, and may exhibit a transmittance of at least about 75%. In some examples, the light 502 is incident to the surface 520 at an angle between about −30° and about 30°, and may exhibit a transmittance of at least about 90%. For example, light emitted or reflected from real-world objects, such as real-world object 524, is transmitted through the angularly selective diffusive combiner 205 without appreciable scattering to the user's eye 510. As such, the user's eye 510 can view the real-world object 524 through the angularly selective diffusive combiner 205 transparently with a high clarity. In some examples, the artificial reality system 500 may be viewed by any imaging system 510, for example, a camera system 510 including a lens and a focal plane array.

In the example shown, the angularly selective diffusive combiner 205 is scattering for light 504 incident to a major surface 522 of the angularly selective diffusive combiner 205 at a second angle or range of angles. In the example shown, the diffusive combiner 205 is scattering for the light 504 incident to the major surface 522 for all angles other than normal or near-normal incident angles. Light emitted from the projector 148 is incident on the angularly selective diffusive combiner 205 at an angle. In some examples, a compact optical system can collect and direct light from projector 148 to angularly selective diffusive combiner 205 at an angle, and the compact optical system may include one or more of lenses, prisms, gratings, waveguides, and the like.

In the example, shown, a portion of the light from the projector 148 is diffusely transmitted through the angularly selective diffusive combiner 205, e.g. scattered and transmitted, and a portion of the light is diffusely reflected by the angularly selective diffusive combiner 205, e.g. scattered and reflected light 506. In the example shown, the diffusely reflected portion of the light 506 from the projector 148 scatters towards, and is captured by, the user's eye 510. As such, the angularly selective diffusive combiner 205 can act as a projection screen illuminated by the projector 148 and viewable by the user's eye 510. In some examples, the projector 148 provides virtual content, e.g. illuminates the angularly selective diffusive combiner with the virtual object 120. As such, the angularly selective diffusive combiner 205 can merge the real-world optical path 502, 503 of the real-world object 524 to the user's eye 510 and the virtual content optical path 504, 506 of the virtual object 120 to the user's eye 510, thereby combining the real-world content and virtual content. In the example shown, the user's eye 510 can image both the real-world object 524 and the virtual content 120 in combination as the mixed-reality object or scene 526.

In the example shown, angularly selective diffusive combiner 205 may include substrates having major surfaces 522, 520. In some examples, the substrates of angularly selective diffusive combiner 205 may be planar. In other examples, the substrates of angularly selective diffusive combiner 205 may be curved.

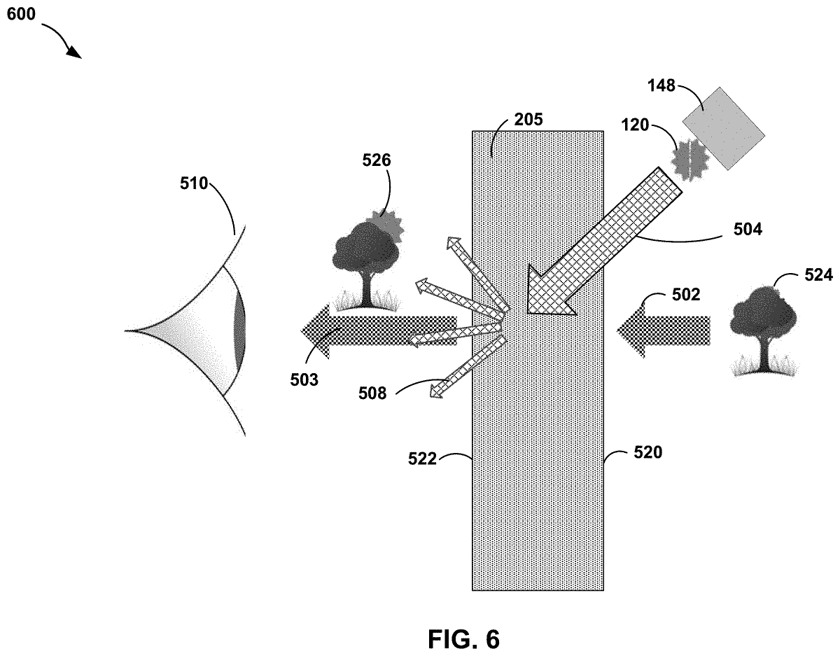

FIG. 6 is an illustration depicting another example artificial reality system 600 that includes an angularly selective diffusive combiner, in accordance with the techniques described in this disclosure. The artificial reality system 600 is similar to the artificial reality system 500 of FIG. 5, except the projector is positioned on the side of the angularly selective diffusive combiner 205 opposite the user's eye 510 and illuminates the angularly selective diffusive combiner 205 at an angle from the side opposite the user's eye 510.

In the example shown, the angularly selective diffusive combiner 205 is substantially transparent for light 502 incident to a major surface 520 of the angularly selective diffusive combiner 205 at a first angle or range of angles. In the example shown, the light 502 is incident to the surface 520 at normal incidence or at near-normal incidence. For example, light emitted or reflected from real-world objects, such as real-world object 524, is transmitted through the angularly selective diffusive combiner 205 without appreciable scattering to the user's eye 510. As such, the user's eye 510 can view the real-world object 524 through the angularly selective diffusive combiner 205 transparently with a high clarity.

In the example shown, the angularly selective diffusive combiner 205 is scattering for light 504 incident to a major surface 520 of the angularly selective diffusive combiner 205 at a second angle or range of angles. In the example shown, the diffusive combiner 205 is scattering for the light 504 incident to the major surface 522 for all angles other than normal or near-normal incident angles (e.g., angles greater than about 30° and less than about 90°) with the scattering intensity increasing with the incidence angle. Because of latter property, the high incidence angle is preferable to increase brightness of virtual image. For example, light emitted from the projector 148 is incident on the angularly selective diffusive combiner 205 at an angle to the surface 520, and a portion of the light from the projector 148 is diffusely transmitted 508 through the angularly selective diffusive combiner 205, e.g. scattered and transmitted, and a portion of the light is diffusely reflected by the angularly selective diffusive combiner 205, e.g. scattered and reflected. In the example shown, the diffusely transmitted 508 portion of the light from the projector 148 scatters towards, and is captured by, the user's eye 510. As such, the angularly selective diffusive combiner 205 can act as a rear-projection screen illuminated by the projector 148 and viewable by the user's eye 510. In some examples, the projector 148 provides virtual content, e.g. illuminates the angularly selective diffusive combiner with the virtual object 120. As such, the angularly selective diffusive combiner 205 can merge the real-world optical path 502, 503 of the real-world object 524 to the user's eye 510 and the virtual content optical path 504, 508 of the virtual object 120 to the user's eye 510, thereby combining the real-world content and virtual content. In the example shown, the user's eye 510 can view both the real-world object 524 and the virtual content 120 in combination as the mixed-reality object or scene 526.

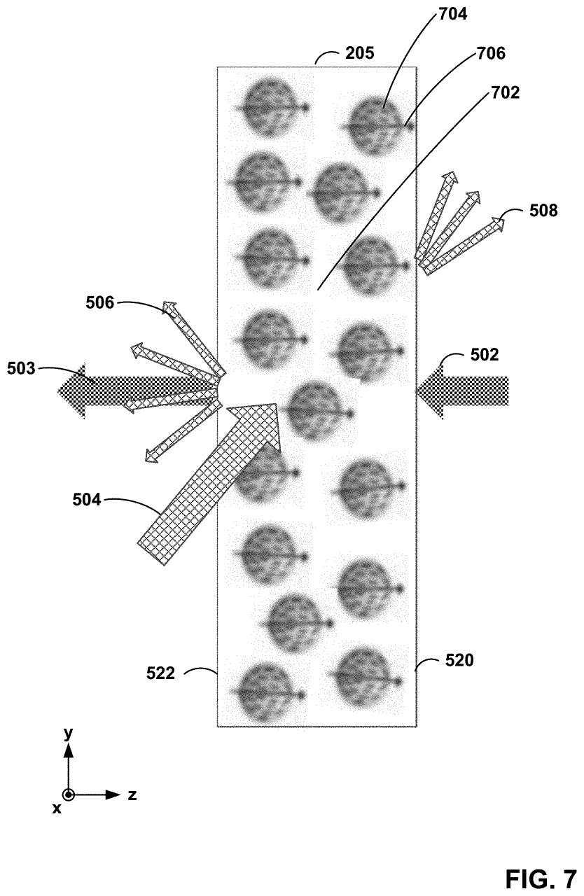

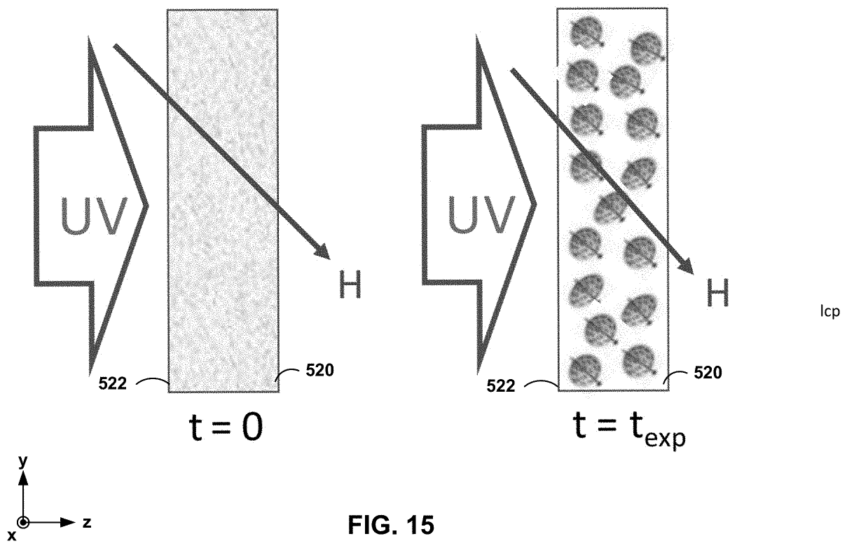

FIG. 7 is an illustration depicting an example angularly selective diffusive combiner 205, in accordance with techniques described in this disclosure. In the example shown, the diffusive combiner 205 includes a polymer dispersed liquid crystal (PDLC) and includes liquid crystal 704 and polymer 702. The liquid crystal 704 is located within droplets or domains formed in a matrix of the polymer 702 during photopolymerization. In other examples, the diffusive combiner 205 is formed from a light-transmitting porous material in which the pores are filled with an anisotropic material, as further described below with respect to FIG. 15. In some examples, the elongated pores are vertically aligned, that is, the pores have a major axis that is perpendicular, or substantially perpendicular, to a major surface 520, 522 of the diffusive combiner 205. In the example shown, liquid crystal 704 is aligned along the pore walls and thus perpendicularly to major surfaces 520, 522 of the diffusive combiner 205 and parallel with the major axis of the pores. In some examples, angularly selective diffusive combiner 205 may include any appropriate anisotropic material in an isotropic matrix.

In the example shown in FIG. 7, the liquid crystal 704 is aligned substantially vertically, that is, the liquid crystal molecules have a director that is perpendicular, or substantially perpendicular (e.g. to within 30 degrees from normal), to a major surface 520, 522 of the PDLC 205, e.g. along the z axis as illustrated. In some examples, the ordinary refractive index of the liquid crystal 704 matches the index of refraction of the polymer 702. For example, nₚ=nₒ<nₑ, where nₒ and nₑ are the ordinary and extraordinary refractive indices of the liquid crystal 704 and nₚ is the refractive index of the polymer. Because the liquid crystal is birefringent, the refractive index of the liquid crystal depends on the polarization and the propagation direction of light relative to the director 706 of the liquid crystal 704. The propagation of normally incident light 502 is substantially parallel with the director 706 of the liquid crystal, and therefore the effective index of the liquid crystal 704 for the light 502 is the ordinary refractive index, nₒ, regardless of the polarization of the normally incident light 502. In the example shown, the polymer index nₚ is substantially the same as the ordinary refractive index, nₒ, of the liquid crystal 704, and there is no index difference between the droplets of liquid crystal 704 and the polymer 702. Therefore, the liquid crystal 704 droplets do not scatter the normally incident light 502 and diffusive combiner 205 is substantially transparent to normally incident light 502. As a result, light 502 that is incident to the diffusive combiner 205 parallel with the liquid crystal director 706, e.g. normally incident in the example shown, is transparently transmitted through the diffusive combiner 205, e.g. transmitted with little or no scattering and resulting in transparently transmitted light 503.

In other examples, director 706 of liquid crystal in the porous material is aligned along the major axis of the vertically aligned pores, and the porous material has an index of refraction nₚ that matches the ordinary refractive index of liquid crystals 704, e.g. nₚ=nₒ, as further described with respect to FIG. 15 below. Similar to the PDLC, normally incident light 502 is transparently transmitted through the diffusive combiner 205 formed from a liquid crystal filled porous material because of the index match between the porous material and liquid crystals 704 filling the pores.

In some examples, the droplets or pores of anisotropic material, e.g. liquid crystal 704, may be interconnected within the isotropic material, e.g. the polymer, as opposed to forming isolated droplets or pores as illustrated in FIG. 7. In some examples, the liquid crystal 704, or anisotropic material, can form a permanent phase, while a polymer forms a network.

In the example shown in FIG. 7, light 504 is incident to diffusive combiner 205 at a non-normal angle to a major surface 522 of diffusive combiner 205. The propagation of light 504 is not parallel with, nor orthogonal to, director 706 of liquid crystal 704. Therefore, the effective refractive index of liquid crystal 704 for light 504 is no longer the ordinary refractive index nₒ, but rather is in between the ordinary (nₒ) and extraordinary (nₑ) indices of liquid crystal 704 and also depends on the polarization of light 504. As a result, a portion of light 504 is scattered in both transmission 508 and reflection 506 by the refractive index mismatch of liquid crystal 704 and polymer 702. In examples in which diffusive combiner 205 is formed of liquid crystal 704 filling the pores of a porous material, there will be a similar index mismatch of the liquid crystal 704 and the porous material for light incident at a non-normal angle, which scatters the light 504 in both transmission and reflection.

In the example shown, the diffusely transmitted 508 portion of light causes image leakage, e.g. diffusely transmitted 508 light leaks and exits angularly selective diffusive combiner 205, which may possibly cause a loss of privacy regarding the information included in the diffusely transmitted light 508 and associated image. In some examples, a polarizer may be positioned adjacent to a major surface of angularly selective diffusive combiner 205, e.g. adjacent to major surface 520, to reduce or eliminate leakage of diffusely transmitted light 508. In some examples, a dimming device such as a guest-host liquid crystal layer, an electrochromic dimmer, a privacy filter, etc., may be included to reduce or eliminate leakage of diffusely transmitted light 508.

In some examples, director 706 of liquid crystal 704 within droplets or domains 205 of the PDLC (or alternatively within the pores of a porous material) may be tilted, or at an angle, with respect to a major surface 520, 522 of the diffusive combiner 205, e.g. not vertically aligned. As such, there may be an index mismatch between the polymer (or porous material) and liquid crystal 704 for normally incident or near-normal incident light 502. In addition, the index mismatch for light 504 incident non-normally to diffusive combiner 504 may be increased by the tilted liquid crystal director 706. For modest liquid crystal director 706 tilt angles, e.g. less than 30 degrees, diffusive combiner 205 may still be substantially transparent to normally incident light 502 can still but exhibit some scattering, while exhibiting increased scattering for non-normally incident light 504. An advantage of such a diffusive combiner 205 is the ability to balance a higher scattering strength, e.g. brightness of virtual content from the projector 148, while reducing or minimizing the scattering of normal, or near-normal, light 502, e.g., reducing or minimizing the scattering of light from real-world objects 524.

In some examples, the diffusive combiner 205 can be used to electronically control the brightness of the virtual and the real-world images. For example, an electric field can be applied to the diffusive combiner 205, thereby rotating the director 706 of the liquid crystal 704. The rotation of the director 706 of the liquid crystal 704 depends on the dielectric anisotropy of the liquid crystal and the strength of the applied electric field, and the effective index of refraction of the liquid crystal 704 depends on the rotation of the director 706 relative to the incidence angle of the light from the virtual or real-world objects or scenes. As such, the effective index of refraction of the liquid crystal 704, and thus the index mismatch with the polymer 702 (or alternatively the porous material) for the normally incident light 502 and the non-perpendicular light 504 can be electrically controlled. In some examples, the diffusive combiner 205 may be configured to function as a shutter by scattering incident light such that substantially little, or none, of the incident light is transmitted. For example, diffusive combiner 205 may scatter the light 502 such that transparently transmitted light 503 is substantially reduced or eliminated.

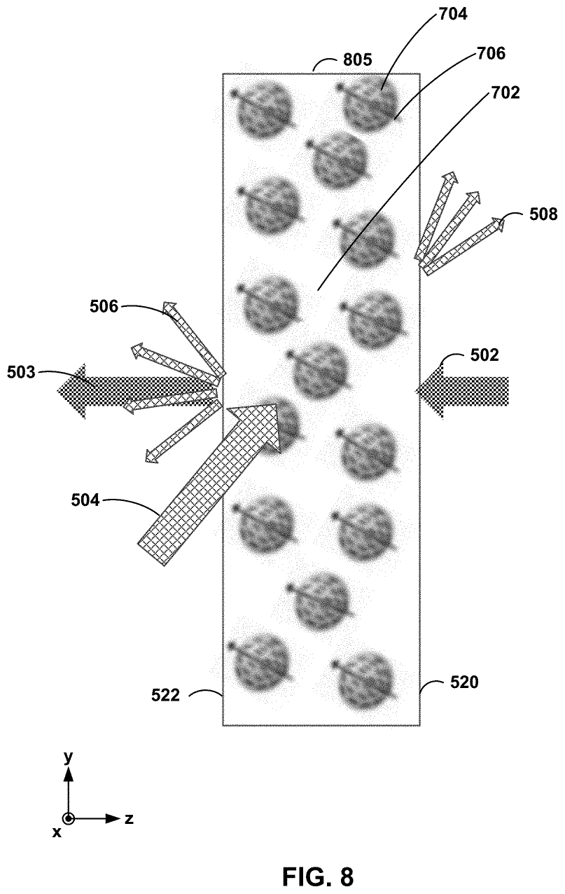

FIG. 8 is another illustration depicting an example angularly selective diffusive combiner 805, in accordance with techniques described in this disclosure. In the example shown in FIG. 8, and similar to the diffusive combiner 205 illustrated and described above with respect to FIG. 7, the diffusive combiner 805 may be a PDLC and includes liquid crystal 704 and polymer 702. Liquid crystal 704 is located within droplets or domains formed in the polymer 702 during photopolymerization of polymer 702. In other examples, diffusive combiner 805 can be formed from a porous material in which the pores are filled with liquid crystal 704. In such examples, pores may be anisotropic, and a long axis of the pores may affect an orientation of the liquid crystal director 706. For example, the pores may be substantially vertically aligned, that is, the pores have a major axis that is perpendicular, or substantially perpendicular, to a major surface 520, 522 of diffusive combiner 805, which may result in director 706 of liquid crystal 704 being oriented perpendicular, or substantially perpendicular, to major surfaces 520, 522 of diffusive combiner 805.

In the example shown, liquid crystal director 706 is aligned at a tilt angle in each of the droplets or pores, that is, the liquid crystal molecules 704 have a director 706 that is at an angle relative to major surfaces 520, 522 of the PDLC 805. In the example shown, the liquid crystal director 706 is tilted with respect to the z axis. In some examples, liquid crystal 704 is aligned via planar anchoring. For example, liquid crystal 704 may be anchored at the interface with the surrounding material, e.g., polymer. The droplets or pores may be bipolar and may have a major axis connecting the poles. As such, although the liquid crystal director 706 of the molecules of liquid crystal material 704 may not be uniformly aligned, the average director 706 may align parallel with the major axis of the bipolar droplet or pore.

In some examples, the ordinary refractive index, nₒ, of liquid crystal 704 is less than the index of refraction of polymer 702. Polymer 702 may be isotropic, such that its index of refraction is the same along all axes. For example, nₒ<nₚ<nₑ, where nₒ and nₑ are the ordinary and extraordinary refractive indices of liquid crystal 704 and nₚ is the refractive index of the polymer. In the example shown, the propagation of normally incident light 502 is at an angle, e.g. the tilt angle, relative to director 706 of liquid crystal 704, and therefore the effective index of liquid crystal 704 for normally incident light 502 is greater than the ordinary refractive index, nₒ, and between the ordinary refractive index, nₒ, and the extraordinary refractive index, nₑ. In some examples, the effective index of liquid crystal 704 for light 502 is equal to the polymer (or porous material) refractive index nₚ, and the liquid crystal 704 droplets substantially do not scatter the normally incident light 502. As a result, light 502 that is incident to diffusive combiner 805 at an angle to director 706, e.g. the tilt angle, with respect to the liquid crystal director 706 is transparently transmitted through the diffusive combiner 205, e.g. resulting in transparently transmitted light 503. In some examples, as shown in FIG. 8, this may result in diffusive combiner 805 being substantially transparent to substantially normally incident light 502, by choosing polymer 702 and liquid crystal 704 such that the effective refractive index of liquid crystal 704 at the tilt angle is substantially equal to the refractive index of polymer 702.

In the example shown in FIG. 8, the light 504 is incident to diffusive combiner 805 at an angle to a major surface 522 of diffusive combiner 805. The propagation of non-normally incident light 504 is at an angle with respect to director 706 of liquid crystal 704 that is greater than the tilt angle. Therefore, the effective refractive index of liquid crystal 704 for light 504 is closer to nₑ and thus the mismatch with the polymer refractive index nₚ is stronger, e.g. the difference between the effective index of liquid crystal 704 for light 504 and the polymer refractive index for the light 504 is greater, for example, greater than for normally incident light 502, or any incident light at an angle that is not greater than the tilt angle. As a result, a portion of light 504 is scattered in both transmission 508 and reflection 506 by the index mismatch of liquid crystal 704 and polymer 702. In some examples, diffusive combiner 805 is formed of liquid crystal 704 filling the pores of a porous material, and there can be a similar index mismatch of liquid crystal 704 and the porous material thereby scattering non-normally incident light 504 in both transmission 508 and reflection 506.

In some examples, the propagation of non-normally incident light 504 is at a greater angle relative to director 706 of liquid crystal 704 for the same incident angle relative to the major surfaces 520, 522 of diffusive combiner 805 as compared with the diffusive combiner 205 illustrated and described above with respect to FIG. 7. As a result, the index mismatch between the effective index of liquid crystal 704 having titled director 706 with respect to the major surfaces of diffusive combiner 805 for non-normally incident light 504 can be greater than the index mismatch for non-normally incident light 504 for diffusive combiner 205 having substantially vertically aligned liquid crystal director 706 as illustrated in FIG. 7. Therefore, the scattering by diffusive combiner 805 for non-normally incident light 504 can be greater than diffusive combiner 205 for non-normally incident light 504 at the same incidence angle with respect to major surfaces 520, 522 of diffusive combiners 205, 805. In some examples, the greater scattering of diffusive combiner 805 having tilted liquid crystal director 706 for non-normally incident light 504 results in brighter virtual content, for example, virtual object 120 combined with real-world content 524 by diffusive combiner 805. In other words, having tilted liquid crystal director 706 tilted at an angle that results in a more orthogonal orientation of liquid crystal director 706 relative to non-normally incident light 504 may result in greater scattering of non-normally incident light 504.

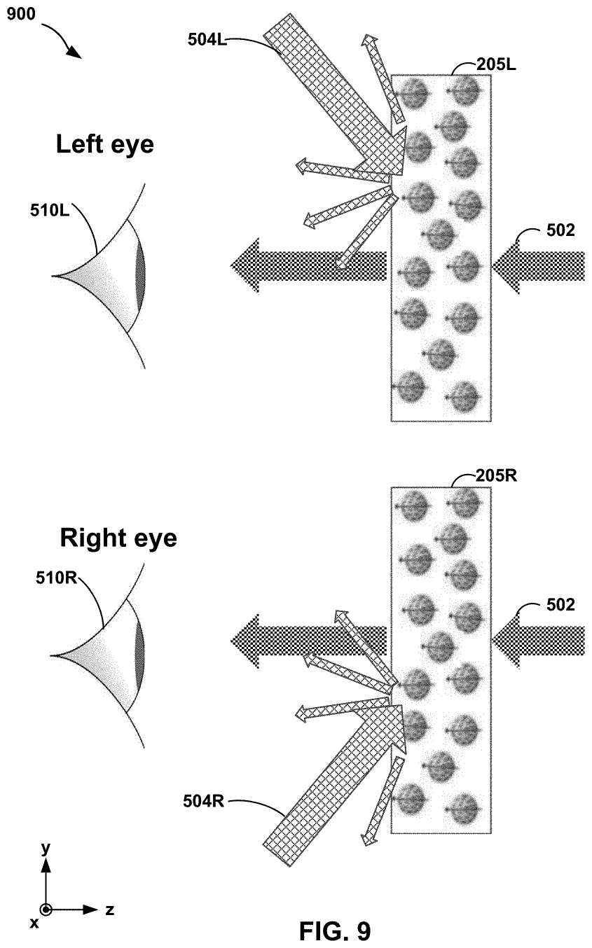

FIG. 9 is an illustration depicting one or more angularly selective diffusive combiners 205L, 205R in a stereoscopic artificial reality (AR) system 900, in accordance with techniques described in this disclosure. In the example shown, the AR system 900 includes a left diffusive combiner 205L and a right diffusive combiner 205R, normally incident light 502, the light 504L incident on the diffusive combiner 205L at an angle, and the light 504R incident on the diffusive combiner 205R at an angle.

In the example shown, both the left diffusive combiner 205L and the right diffusive combiner 205R can be a PDLC with substantially vertically aligned liquid crystal and indices of refraction nₚ=nₒ<nₑ, as described above with respect to FIG. 7. Alternatively, the diffusive combiners 205L and 205R can be a porous material having pores vertically aligned and containing vertically aligned liquid crystal having indices of refraction of nₚ=nₒ<nₑ. In some examples, the AR system 900 can include a single diffusive combiner 205 rather than left and right diffusive combiners 205L and 205R. In the example shown, the light 502 can include light from real-world objects, for example, the real-world object 524 as illustrated and described above with respect to FIG. 5. The light 504L can include light from a first projector 148 and scatter from the diffusive combiner 205L towards a left eye 510L of a user. The light 504R can come from a second projector 148 and scatter from the diffusive combiner 205R towards a right eye 510R of a user. In some examples, the light 504L and the light 504R can include virtual content projected by the first and second projectors 148 including depth information, for example, stereoscopic views of the virtual content presented individually to the left and right image capture systems 510.

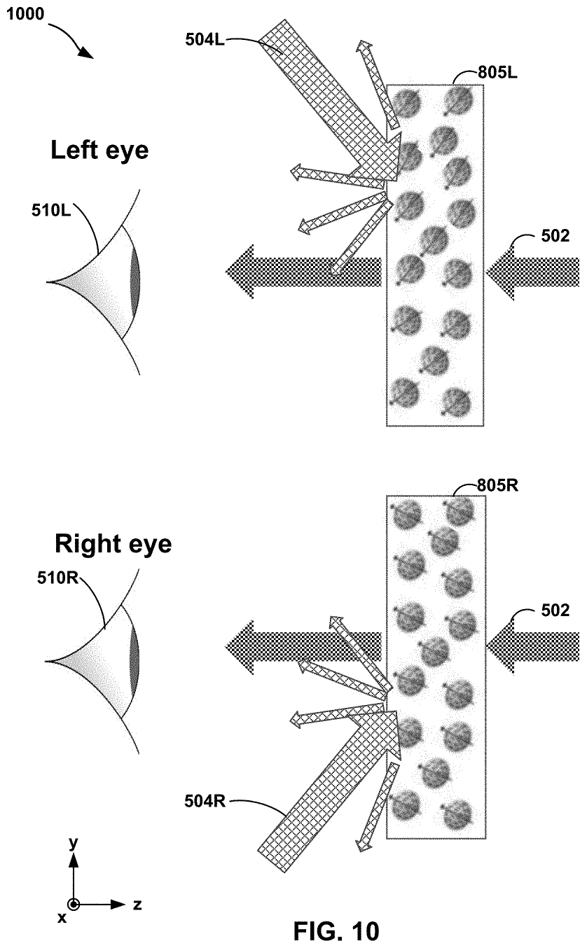

FIG. 10 is an illustration depicting another one or more angularly selective diffusive combiners 805L, 805R in a stereoscopic artificial reality system 1000, in accordance with techniques described in this disclosure. In the example shown, the AR system 1000 includes a left diffusive combiner 805L and a right diffusive combiner 805R, normally incident light 502, the light 504L incident on the diffusive combiner 205L at an angle, and the light 504R incident on the diffusive combiner 205R at an angle.

The example illustrated in FIG. 10 corresponds to the example described above with respect to FIG. 9, but the directors of the liquid crystal of the diffusive combiners 805L and 805R are tilted with respect to a major surface of the respective combiner, rather than being vertically aligned, and have indices of refraction nₒ≤nₚ<nₑ, and described above with respect to FIG. 8. In some examples, the AR system 1000 can include a single diffusive combiner 805 having two different liquid crystal alignment domains rather than left and right diffusive combiners 805L and 805R.

In the example shown, the liquid crystal director 706 of the liquid crystal 704 of the diffusive combiner 805L are tilted with respect to the major surfaces 520, 522 of the diffusive combiner 805L so as to increase the scattering of the light 504L as illustrated and described with respect to FIG. 8 above. In the example shown, the liquid crystal director 706 is tilted about the x-axis, in other examples the liquid crystal director 706 is tilted about the y-axis, and in still other examples the liquid crystal director 706 is tilted about the z-axis. The liquid crystal director 706 of the liquid crystal 704 of the diffusive combiner 805R are tilted with respect to the major surfaces 520, 522 of the diffusive combiner 805R so as to increase the scattering of the light 504R. In the example shown, the tilt angle of the liquid crystal director 706 of the diffusive combiner 805R is in the opposite direction as that of the diffusive combiner 805L since the light 504R is angled oppositely that of the light 504L with respect to the surfaces 520, 522 of the diffusive combiners 805L and 805R. In other examples, the tilt angles of the liquid crystal director 706 of the diffusive combiners 805L, 805R can be in the same direction.

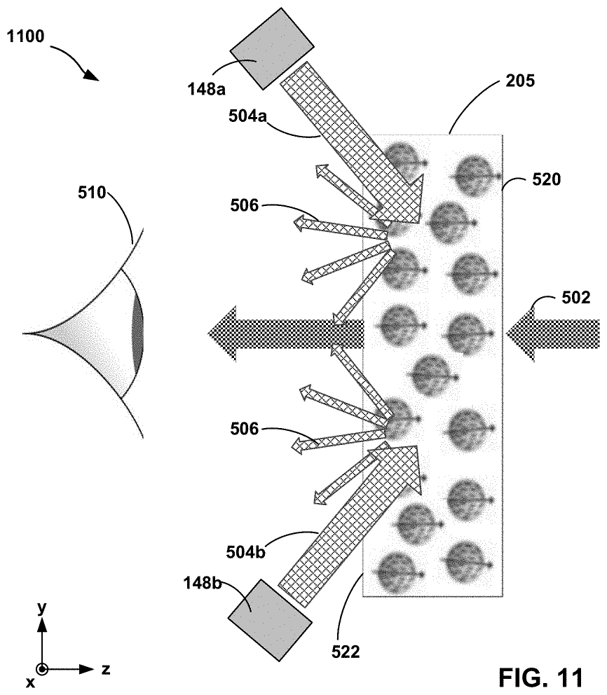

FIG. 11 is an illustration depicting another example angularly selective diffusive combiner 205 in an artificial reality system 1100, in accordance with techniques described in this disclosure. In the example shown, the AR system 1100 includes normally incident light 502 and the light 504a and 504b incident from two different non-perpendicular directions from two projectors 148a and 148b. In some examples, the light 504a and 504b incident from two different non-perpendicular directions can be from one or more projectors, for example, by using a beam splitter and a shutters to select the output of the light 504a and/or 504b. The example shown also includes a user's eye 510, for example, one or more eyes 510 of user 110 as illustrated in FIG. 1.

In the example shown, the liquid crystal director 706 of the diffusive combiner 205 is vertically aligned, as described above with respect to FIG. 7. In some examples, the liquid crystal director 706 can be tilted, e.g. rotated, about x-axis or the y-axis. In some examples, the one or both of the lights 504a and 504b can be selected, for example, to increase or reduce the brightness of the light 506 scattered to the user's eye 510. In some examples, both the projector 148a and the projector 148b output the same virtual content, in other examples the projectors 148a and 148b output different virtual content. In some examples, the projectors 148a and 148b can output strobed light 504a and 504b, either in phase or out of phase with each other, for example to output color virtual content via field sequential color strobing.

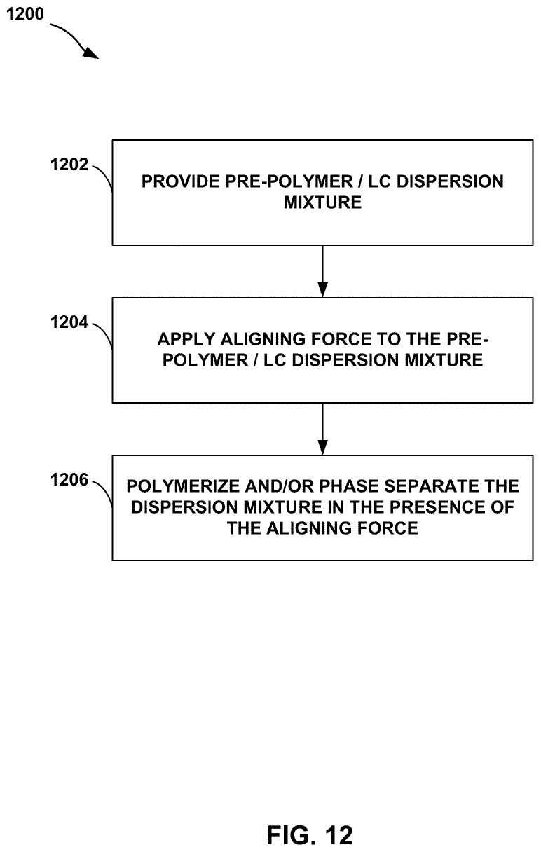

FIG. 12 is a flowchart illustrating an example method 1200 of making an angularly selective diffusive combiner, in accordance with techniques described in this disclosure. In the example shown, a pre-polymer with liquid crystal dispersed in the pre-polymer is provided at step 1202.

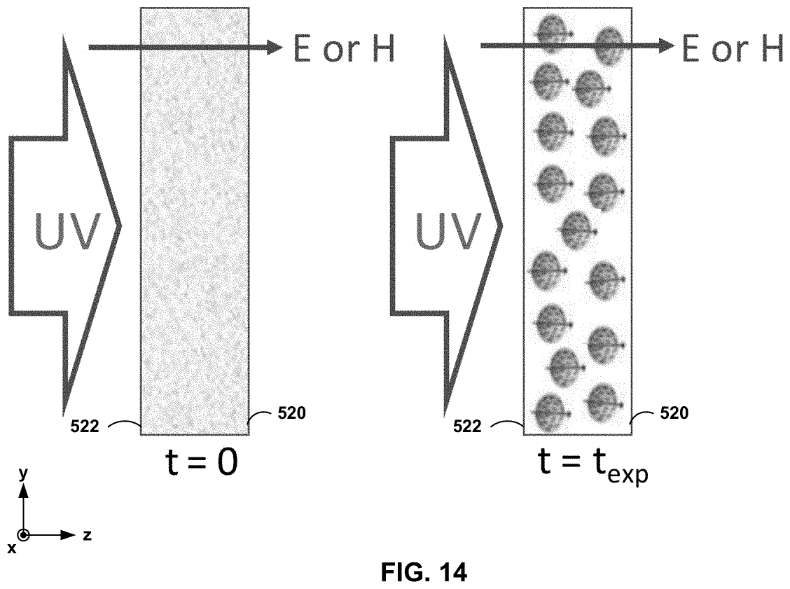

At the step 1204, an alignment force may be applied to the pre-polymer-LC dispersion mixture. In some examples, the applying an alignment force may include application of an electric or magnetic field. For example, the magnetic (H) or electric (E) field may have field lines perpendicular to the major surfaces 520, 522 of the diffusive combiner 205 such that the direction of the H or E field is perpendicular to the major surfaces 520, 522 and causing the liquid crystal directors to align along the direction of the H or E field, as illustrated in FIG. 14. In other examples, the H or E field may be at an angle with respect to the major surfaces 520, 522 and causing the liquid crystal directors to align at a tilt angle along the direction of the applied H or E field, as illustrated in FIG. 15.

In some examples, the alignment force may be caused by alignment layers for homeotropic alignment of the liquid crystal or anisotropic material, e.g., substantially perpendicular to the substrates of the angularly selective diffusive combiner. In some examples, the alignment force may be a mechanical action or force, e.g. stretching of the composite anisotropic and isotropic materials. In some examples, alignment layers or mechanical action may cause alignment of the liquid crystal (or other anisotropic material) at a tilt angle with respect to the substrates, for example, as illustrated in FIG. 8.

At the step 1206, the polymer is polymerized in the presence of the alignment force. For example, the diffusive combiner 205 is exposed to UV light, the UV light catalyzing polymerization of the polymer, in the presence of the alignment force. Polymerizing in the presence of the alignment force, e.g. an H or E field, alignment layers, or mechanical action, etc., creates a preferential alignment of the liquid crystal along the direction of the applied field, according to the alignment layers, or according to the mechanical action.

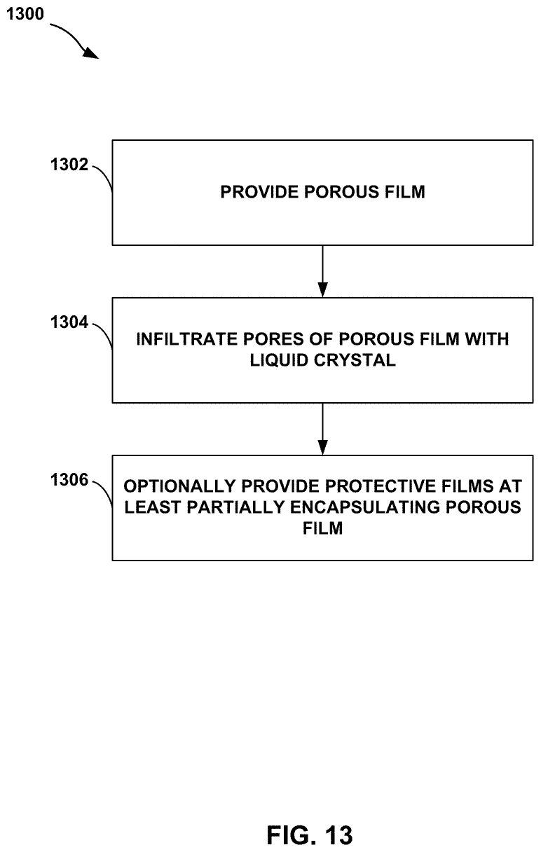

FIG. 13 is a flowchart illustrating an example method 1300 of making an angularly selective diffusive combiner, in accordance with techniques described in this disclosure. In the example shown, a porous film is provided at step 1302. In some examples, the pores may be elongate and may have a preferential alignment within the film, for example, the pores may have a major axis that is substantially perpendicular to a major surface of the film. In some examples, the pores may have a major axis that is at a tilt angle with respect to a major surface of the film. In some examples, the porous film may comprise an organic material, for example a polymer. In other examples, the porous film may comprise an inorganic material, for example a glass.

At the step 1304, the porous film is infiltrated with liquid crystal. In some examples, the director of the liquid crystal within the pores may be aligned with a major axis of the pores.

At the step 1306, protective material may be provided to at least partially encapsulate the liquid crystal within the pores of the porous film. For example, a coating may be applied to the major surfaces of the film, a coating may be applied to the major surfaces of the film, a material may be deposited on the major surfaces of the film, etc. In some examples, the edges of the film may be encapsulated.

FIG. 14 is an illustration depicting example method steps for making an angularly selective diffusive combiner 205 having liquid crystal with a vertical preferential alignment angle, in accordance with techniques described in this disclosure. In the example shown, a magnetic or electric field is applied in a direction perpendicular to a major surface 520, 522 of the diffusive combiner 205. At time t=0, the process of polymerizing the polymer of the diffusive combiner 205 is initiated, for example by exposing the diffusive combiner to UV light to catalyze polymerization. At time t=tₑₓₚ, the polymer is substantially polymerized. In some examples, the diffusive combiner 205 is a PDLC, and the liquid crystal dispersed in the PDLC forms droplets during polymerization having liquid crystal aligned in the direction of the applied H or E field.

FIG. 15 is an illustration depicting example method steps for making an angularly selective diffusive combiner having liquid crystal with a tilted preferential alignment angle, in accordance with techniques described in this disclosure. In the example shown, a magnetic or electric field is applied in a direction at an angle to a major surface 520, 522 of the diffusive combiner 205. At time t=0, the process of polymerizing the polymer of the diffusive combiner 205 is initiated, for example by exposing the diffusive combiner to UV light to catalyze polymerization. At time t=tₑₓₚ, the polymer is substantially polymerized. In some examples, the diffusive combiner 205 is a PDLC, and the liquid crystal dispersed in the PDLC form droplets during polymerization having liquid crystal aligned in the direction of the applied H or E field, e.g. the directors of the liquid crystal are tilted with respect to the major surface 520, 522.

FIG. 15 is an illustration depicting an example angularly selective diffusive combiner 1505, in accordance with techniques described in this disclosure. In the example shown, the diffusive combiner 1505 includes a porous material 1502 including pores 1508 filled with anisotropic material 1504. In some examples, anisotropic material 1504 may be liquid crystal. In some examples, the pores are elongated and vertically aligned, that is, the pores have a major axis that is perpendicular, or substantially perpendicular, to a major surface 520, 522 of the diffusive combiner 1505. In the example shown, anisotropic material 1504 is substantially aligned along the pore walls and thus substantially perpendicularly to major surfaces 520, 522 of the diffusive combiner 1505 and parallel with the major axis of the pores.

In the example shown in FIG. 15, anisotropic material 1504 is aligned substantially vertically, that is, anisotropic material 1504 may have a director 1506 that is perpendicular, or substantially perpendicular (e.g. to within 30 degrees from normal), to a major surface 520, 522 of diffusive combiner 1505, e.g. along the z axis as illustrated. In some examples, the ordinary refractive index of anisotropic material 1504 matches the index of refraction of the porous material 1502. For example, nₚ=nₒ<nₑ, where nₒ and nₑ are the ordinary and extraordinary refractive indices of anisotropic material 1504 and nₚ is the refractive index of the porous material 1502. Because anisotropic material 1504 is birefringent, the refractive index of anisotropic material 1504 depends on the polarization and the propagation direction of light relative to the director 1506 of anisotropic material 1504. The propagation of normally incident light 502 is substantially parallel with the director 1506 of anisotropic material 1504, and therefore the effective index of anisotropic material 1504 for the light 502 is the ordinary refractive index, nₒ, regardless of the polarization of the normally incident light 502. In the example shown, the porous material 1502 index nₚ is substantially the same as the ordinary refractive index, nₒ, of anisotropic material 1504, and there is no index difference between the pores of anisotropic material 1504 and the porous material 1502. Therefore, anisotropic material 1504 pores do not scatter the normally incident light 502 and diffusive combiner 1505 is substantially transparent to normally incident light 502. As a result, light 502 that is incident to the diffusive combiner 1505 parallel with director 1506, e.g. normally incident in the example shown, is transparently transmitted through the diffusive combiner 1505, e.g. transmitted with little or no scattering and resulting in transparently transmitted light 503.

In the example shown in FIG. 15, light 504 is incident to diffusive combiner 1505 at a non-normal angle to a major surface 522 of diffusive combiner 1505. The propagation of light 504 is not parallel with, nor orthogonal to, director 1506. Therefore, the effective refractive index of anisotropic material 1504 for light 504 is no longer the ordinary refractive index nₒ, but rather is in between the ordinary (nₒ) and extraordinary (nₑ) indices of anisotropic material 1504 and also depends on the polarization of light 504. As a result, a portion of light 504 is scattered in both transmission 508 and reflection 506 by the refractive index mismatch of anisotropic material 1504 and porous material 1502.

In some examples, director 1506 of anisotropic material 1504 within pores of porous material 1502 may be tilted, or at an angle, with respect to a major surface 520, 522 of the diffusive combiner 1505, e.g. not vertically aligned. As such, there may be an index mismatch between the porous material and anisotropic material 1504 for normally incident or near-normal incident light 502. In addition, the index mismatch for light 504 incident non-normally to diffusive combiner 504 may be increased by the tilted director 1506. For modest director 1506 tilt angles, e.g. less than 30 degrees, diffusive combiner 1505 may still be substantially transparent to normally incident light 502 but exhibit some scattering, while exhibiting increased scattering for non-normally incident light 504. An advantage of such a diffusive combiner 1505 is the ability to balance a higher scattering strength, e.g. brightness of virtual content from the projector 148, while reducing or minimizing the scattering of normal, or near-normal, light 502, e.g., reducing or minimizing the scattering of light from real-world objects.

As described by way of various examples herein, the techniques of the disclosure may include or be implemented in conjunction with an artificial reality system. As described, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs or videos). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted device (HMD) connected to a host computer system, a standalone HMD, a mobile device or computing system, or any other hardware platform capable of providing artificial reality content to one or more viewers.

The techniques described in this disclosure may be implemented, at least in part, in hardware, software, firmware or any combination thereof. For example, various aspects of the described techniques may be implemented within one or more processors, including one or more microprocessors, DSPs, application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in a computer-readable medium, such as a computer-readable storage medium, containing instructions. Instructions embedded or encoded in a computer-readable storage medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

As described by way of various examples herein, the techniques of the disclosure may include or be implemented in conjunction with an artificial reality system. As described, artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head mounted device (HMD) connected to a host computer system, a standalone HMD, a mobile device or computing system, or any other hardware platform capable of providing artificial reality content to one or more viewers.

What is claimed is:

1. A device configured to output artificial reality content, comprising:
an angularly selective diffusive combiner configured to transparently transmit light normally incident to the angularly selective diffusive combiner and to diffusively scatter light incident to the angularly selective diffusive combiner at a non-perpendicular angle; and
a projector configured to project a virtual image on the angularly selective diffusive combiner at the non-perpendicular angle, wherein the angularly selective diffusive combiner is configured to direct at least some light from the virtual image toward an eyebox.

2. The device of claim 1, wherein the angularly selective diffusive combiner comprises:
first and second opposing surfaces;
a first material disposed between the first and second opposing surfaces; and
a second material disposed between the first and second opposing surfaces and disposed in domains within a matrix of the first material, the second material having an optical index of refraction substantially matching the optical index of refraction of the first material for light normally incident to the first and second surfaces and an optical index of refraction different from the optical index of refraction of the first material for light incident to the first and second surfaces at an non-perpendicular angle.

3. The device of claim 2, wherein the first material comprises a polymer and the second material comprises a liquid crystal such that the polymer and the liquid crystal form a polymer dispersed liquid crystal (PDLC).

4. The device of claim 3, wherein the liquid crystal of the PDLC is aligned substantially perpendicular to the first and second surfaces in the absence of an applied voltage such that the index of refraction of the liquid crystal substantially matches the index of refraction of the polymer for light normally incident to the first and second surfaces and the index of refraction of the liquid crystal is different from the index of refraction of the polymer for light incident to the first and second surfaces at a non-perpendicular angle.

5. The device of claim 3, wherein the liquid crystal of the PDLC is aligned at a non-perpendicular tilt angle with respect to the first and second surfaces such that the index of refraction of the liquid crystal substantially matches the index of refraction of the polymer for light normally incident to the first and second surfaces and the index of refraction of the liquid crystal is different from the optical index of refraction of the polymer for light incident to the first and second surfaces at a non-perpendicular angle.

6. The device of claim 2, wherein the first material is porous defining a plurality of pores aligned substantially normal to the first and second opposing surfaces and the second material comprises a liquid crystal filling the pores and having liquid crystal aligned substantially along major axes of the pores.

7. The device of claim 2, wherein the first material is porous defining a plurality of pores aligned at a non-perpendicular angle to the first and second opposing surfaces and the second material comprises a liquid crystal filling the pores and having liquid crystal aligned along major axes of the pores.

8. The device of claim 3, wherein the liquid crystal has at least one of a positive and a negative dielectric anisotropy.

9. The device of claim 8, wherein the angularly selective diffusive combiner is configured to function as a shutter and controllably, substantially block incident from transmitting through the angularly selective diffusive combiner.

10. The device of claim 1, further comprising a second projector, wherein the first projector is configured to illuminate a first portion of the angularly selective diffusive combiner at a first angle and the second projector is configured to illuminate a second portion of the angularly selective diffusive combiner at a second angle.

11. The device of claim 1, wherein the device is a head-mounted display (HMD).

12. The device of claim 11, wherein the HMD further comprises at least one lens configured allow an eye within the eyebox to focus on the virtual image.

13. A method of forming an angularly selective diffusive combiner, the method comprising:
providing liquid crystal dispersed in a precursor of an isotropic polymer between a first surface and a second surface;
applying an aligning force to align a liquid crystal director of the liquid crystal dispersed in the precursor of the isotropic polymer along a predetermined axis; and
polymerizing the isotropic polymer in the presence of the aligning force.

14. The method of claim 13, wherein the aligning force is caused by at least one of a magnetic field, an electric field, and an alignment layer on at least one of the surfaces causing the liquid crystal to be aligned substantially normal to a major surface of the angularly selective diffusive combiner.

15. The method of claim 13, wherein the alignment force causes the liquid crystal to be aligned at a non-perpendicular tilt angle with respect to a major surface of the angularly selective diffusive combiner.

16. An angularly selective diffusive combiner comprising:
first and second opposing surfaces;
a first material disposed between the first and second opposing surfaces; and
a second material disposed between the first and second opposing surfaces, the second material having an optical index of refraction substantially matching the optical index of refraction of the first material for light normally incident to the first and second surfaces at a first angle and an optical index of refraction different from the optical index of refraction of the first material for light incident to the first and second surfaces at an angle.

17. The angularly selective diffusive combiner of claim 16, wherein the first material is a polymer and the second material is a liquid crystal such that the polymer and the liquid crystal form a polymer dispersed liquid crystal (PDLC).

18. The angularly selective diffusive combiner of claim 17, wherein the liquid crystal of the angularly selective diffusive combiner is vertically aligned such that the index of refraction of the PDLC substantially matches the index of refraction of the polymer for light normally incident to the first and second surfaces and the index of refraction of the PDLC is different from the optical index of refraction of the polymer for light incident to the first and second surfaces at an angle.

19. The angularly selective diffusive combiner of claim 17, wherein the liquid crystal of the angularly selective diffusive combiner is aligned at a tilt angle such that the index of refraction of the PDLC substantially matches the index of refraction of the polymer for light normally incident to the first and second surfaces and the index of refraction of the PDLC is different from the optical index of refraction of the polymer for light incident to the first and second surfaces at an angle.

20. The angularly selective diffusive combiner of claim 16, wherein the first material is porous having vertically aligned pores and the second material is a liquid crystal filling the vertically aligned pores and having liquid crystal aligned along the pores.

21. The angularly selective diffusive combiner of claim 16, wherein the first material is porous having vertically aligned pores and the second material is a liquid crystal filling the vertically aligned pores and having liquid crystal aligned along major axes of the pores.

22. The angularly selective diffusive combiner of claim 17, wherein the liquid crystal has at least one of a positive and a negative dielectric anisotropy.

23. The angularly selective diffusive combiner of claim 17, wherein the second material comprises an anisotropic material, and wherein the second material is dispersed in the first material and aligned within the first material at a predetermined angle with respect to a major surface of the angularly selective diffusive combiner.

24. A method of forming an angularly selective diffusive combiner, the method comprising:
providing a porous film;
infiltrating the porous film with liquid crystal; and
aligning a liquid crystal director of the liquid crystal along a predetermined axis.
